(19) United States
(12) Patent Application Publication
(10) Pub. No.: US 2026/0233717 A1
(43) Pub. Date: Aug. 13, 2026

(54) SYSTEM AND METHOD FOR REDUCING BRAKE NOISE IN A VEHICLE USING ELECTRONIC BRAKE SYSTEM HAVING ELECTROMECHNICAL BRAKES

(71) Applicant: AUMOVIO Systems, Inc., Auburn Hills, MI (US)

(72) Inventors: Clinton L. Schumann, Holly, MI (US); Christine M. Mackiewicz, Auburn Hills, MI (US)

(73) Assignee: AUMOVIO Systems, Inc., Auburn Hills, MI (US)

(21) Appl. No.: 19/531,179

(22) Filed: Feb. 5, 2026

Related U.S. Application Data
(60) Provisional application No. 63/755,904, filed on Feb. 7, 2025.

(51) Int. Cl. B60T 8/172; B60T 8/171; B60T 8/26; B60T 8/58; F16D 65/00

(52) U.S. Cl. CPC B60T 8/172; B60T 8/171; B60T 8/26; B60T 8/58; F16D 65/0006; B60T 2250/04; B60T 2270/604

(57) ABSTRACT

A method of reducing brake noise in a vehicle brake system includes determining if the vehicle is operating under a condition where brake noise can occur, determining an application force for an actuator for each of the plurality of brakes, and controlling one of the actuator for one of the plurality of brakes to selectively modulate the application force to a respective rotor of the one of the plurality of brakes. The modulated application force is different from the application force to at least another rotor of the plurality of brakes to reduce the brake noise of that one of the plurality of brakes while ensuring adequate braking of the vehicle.

### CROSS REFERENCE TO RELATED APPLICATION

This application claims priority to U.S. Provisional Application Ser. No. 63/755,904 filed Feb. 7, 2025.

### TECHNICAL FIELD

The invention relates to a vehicle brake system and, in particular, to a vehicle electronic brake system that reduces brake noise, such as creep groan of the brakes.

### BACKGROUND

The future trend for automotive braking systems is to eliminate hydraulic fluid. The next generation non-hydraulic brakes will be electro-magnetic. Whereby an electric motor will provide the brake forces. Like the hydraulic systems, a friction material will be pressed onto a rotating rotor or drum surface. These designs are well understood, and will at least initially be utilized, and overtime maybe more advanced designs will be developed. There will also be transition period where both hydraulic and non-hydraulic systems are used together. However, in time, the vacuum booster, master cylinder, pedal with a connection thru the firewall, and hydraulic ABS modulator will become obsolete.

Electro-magnetic calipers or drums (EMBs) will then be directed by a controller(s) via electrical wires. Therefore, there will not be a physical mechanical connection between the brake pedal and the brakes. This will allow new features, as the brake pedal is separated from the corner brakes (brake by wire). For example, the driver may depress the brake pedal slightly whereby the driver is requesting a small amount of deceleration, whereby all four brakes would not necessarily have to actuate, the deceleration could be provided by only two brakes. Some of these strategies were possible with hydraulic systems using hydraulic modulator activities, but the EMBs will open up this potential much further, without having to actuate valves, or restricting hydraulic pressure, etc.

“Creep Groan” is a common foundation brake complaint, generally noticeable as a vehicle's brakes are slowly applied or released at very low speeds. It is thought to be caused by the brake lining and rotor transitioning from static to sliding friction (or vise versa). This transition is then heard audibly and potentially felt by the driver via the brake pedal is mechanically connected and potentially felt in the steering wheel.

Thus, there is a need to provide a vehicle electronic brake system that reduces brake noise.

### SUMMARY

A method of reducing brake noise in a vehicle brake system including a plurality of brakes, the method, according to an exemplary embodiment of this disclosure, among other possible things includes determining if the vehicle is operating under a condition where brake noise can occur, determining an application force for an actuator for each of the plurality of brakes; and controlling the actuator for one of the plurality of brakes to selectively modulate the application brake force to a respective rotor of the plurality of brakes, wherein the modulated application of brake force is different from the application of brake force to at least another rotor of the plurality of brakes to reduce the brake noise of that one of the plurality of brakes when the brake pedal is actuated by a driver of the vehicle, while ensuring adequate braking of the vehicle.

In a further embodiment of the foregoing method, each of the plurality of brakes include a caliper and further include isolating the application of brake force by the caliper from activation of the brake pedal when the driver actuates the brake pedal such that the application of brake force is not proportional to activation of the brake pedal.

In a further embodiment of any of the foregoing methods, the plurality of brakes includes rear wheel brakes and front wheel brakes that include a pair of front wheel brakes and controlling the actuator includes reducing an application of the brake force by the front wheel brakes relative to the application force at the rear wheel brakes.

In a further embodiment of any of the foregoing methods, the rear wheel brakes include a pair of rear wheel brakes and controlling the actuator includes reducing an application of the brake force at each of the rear wheel brakes so as to delay release of the caliper of each of the rear wheel brakes relative to the release of the caliper at each of the front wheel brakes.

In a further embodiment of any of the foregoing, the method further includes controlling a caliper of one of the front wheel brakes and a caliper of one of the rear wheel brakes so as to delay release thereof relative to calipers of another of the plurality of brakes.

In a further embodiment of any of the foregoing, the method further includes preventing select ones of the calipers from engaging associated rotors and the method further includes capturing energy during control of the actuator, such as during regenerative braking.

In a further embodiment of any of the foregoing, the method further includes determining whether the vehicle is operating under a condition where brake creep groan can occur.

In a further embodiment of any of the foregoing, the method further includes determining if the vehicle is operating under a condition where brake noise can occur includes sensing a speed of the vehicle below a predefined speed indicative of operation of the vehicle at an idle speed.

In a further embodiment of any of the foregoing, the method further includes determining that the vehicle is operating under a condition where brake noise can occur based on sensing a temperature indicative of a temperature of the plurality of brakes that is below a predefined temperature.

In a further embodiment of any of the foregoing methods, determining if the vehicle is operating under a condition where brake noise can occur includes detecting conditions at vehicle speeds that cause brake judder where a brake lining of at least one of the plurality of brakes to move in a direction transverse to a direction of the application of braking force.

In a further embodiment of any of the foregoing methods, controlling one of the actuators of one of the plurality of brakes to reduce a potential for brake noise based on movement of the brake lining includes adding braking force to a wheel brake that is opposite the brake operating under the condition where brake noise may occur on a brake on another axle.

A device for reducing brake noise in a vehicle brake system includes a plurality of brakes activated by a brake pedal, the device, according to another exemplary embodiment of this disclosure, among other possible things includes one or more processors that are configured to determine if the vehicle is operating under a condition where brake noise can occur, and determine an application force for an actuator for each of the plurality of brakes, control one of the actuators for one of the plurality of brakes to selectively modulate the application force to a respective rotor of the one of the plurality of brakes, the modulated application force is different from the application force to at least another rotor of the plurality of brakes to reduce the brake noise of that one of the plurality of brakes when the brake pedal is actuated by a driver of the vehicle, while ensuring adequate braking of the vehicle.

In a further embodiment of the foregoing device, the actuator for each of the plurality of brakes includes a caliper and the one or more processors are further configured to isolate the calipers from the driver when the driver actuates the brake pedal.

In a further embodiment of any of the foregoing devices, the plurality of brakes includes rear brakes and front brakes, and a pair of front wheel brakes and the one or more processors are further configured for controlling the caliper of each front wheel brakes to reduce application force thereof relative to the application force at the rear brakes.

In a further embodiment of any of the foregoing devices, the rear wheel brakes include a pair of rear wheel brakes and the one or more processors are further configured for controlling the caliper of each rear wheel brake so as to delay release of the caliper of each rear wheel brake relative to the release of the caliper at each front wheel brake.

In a further embodiment of any of the foregoing devices, the plurality of brakes include a pair of front wheel brakes and a pair of rear wheel brakes, and the one or more processors are further configured for controlling a caliper of one of the front wheel brakes and a caliper of one of the rear wheel brakes so as to delay release thereof relative to the calipers of another of the front wheel brakes and the rear wheel brakes.

In a further embodiment of any of the foregoing devices, the one or more processors are further configured for preventing select ones of the calipers from engaging associated rotors when applying different brake forces to different ones of the plurality of brakes.

In a further embodiment of any of the foregoing devices, the one or more processors are further configured to capture energy during the application of force to any one of the plurality of brakes, such as during regenerative braking.

In a further embodiment of any of the foregoing devices, the one or more processors are further configured to determine whether the vehicle is operating under a condition where brake creep groan can occur and to control at least one of the actuators for one of the plurality of brakes based on the determined operating condition.

These and other features disclosed herein can be best understood from the following specification and drawings, the following of which is a brief description.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic view of an electronic brake system for reducing brake noise such as creep groan in accordance with an embodiment.

FIG. 2 is a flowchart showing the steps to reduce creep groan using the system of FIG. 1.

### DETAILED DESCRIPTION

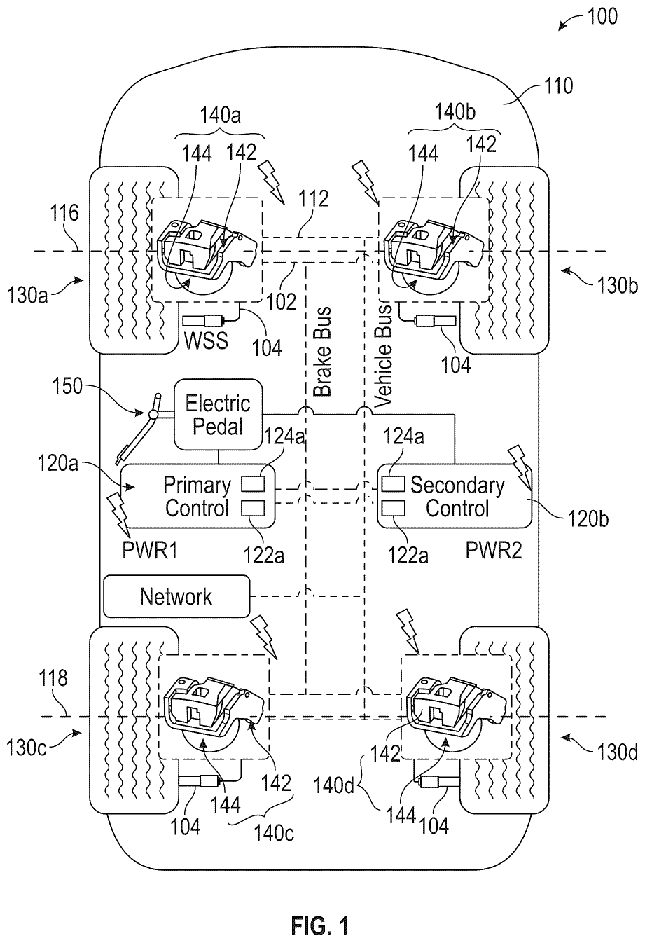

With reference to FIG. 1, a vehicle electronic brake system is shown, generally indicated at 100, in accordance with an embodiment. The electronic brake system 100 is located in a vehicle 110.

The brake system 100 includes first and second controllers 120a, b, a plurality of corner units 130a, b, c, d, disposed at each corner of the vehicle 110. Each of the corner units have an electro-mechanical brake (EMB) assembly 140a, b, c, d, which include an actuator 142, i.e., a caliper and rotor a 144. The term EMB caliper and rotor are used generically to reference the brake actuator (caliper, or drum spread actuator) and rotor or exterior drum. The term lining is also used generically and interchangeably with friction material, lining, and pad.

Additionally, the brake system 100 includes a control input device 150, for example an electronic pedal as shown schematically in FIG. 1. The input device 150 may be electronically connected the first and second controller 120a, b to provide a “brake-by-wire” braking system. In one example embodiment, the brake force applied by the brake system is proportional to a force on the brake pedal. In another example embodiment, the brake system 100 applies a brake force that is not proportional to the amount of force exerted on the brake pedal to all of the plurality of brake assemblies 140a-d. The control input device 150 may be operated without driver input for vehicles that are configured for autonomous operation. Accordingly, although a brake pedal is disclosed by way of example, other control input devices that operate independent and separate from a driver are within the contemplation and scope of this disclosure.

The input device 150, first and second controllers 120a, b and the corner units may be electronically connected to one another via a brake bus 102 and further, possibly redundantly, connected to a vehicle bus 112 for communication with each other and various vehicle systems.

The first controller 120a may be associated as the primary controller of the brake assemblies 140a, b associated with a front axle 116 of the vehicle 110 while the second controller 120b may be associated as the primary controller of the brake assemblies 140c, d associated with a rear axle 118 of the vehicle 110. Each of the controllers 120a, 120b may also function as a redundant controller for the corner units 120 associated with the opposite axle. Alternatively, each corner unit 103 may have a separate controller 120. For example, the first controller and second controller 120a, b may each have multiple circuits that independently control each of the brake assemblies 140. Regardless, each of the brake assemblies 140 can be operated independently from one another using individual control strategies as explained in further detail below.

As shown in FIG. 1, the components of the brake system 100 may be part of a brake system modulator or control unit 120a, b that includes a processor circuit(s) 124a, b. The control unit 120 and processor circuits 124a, b are alternatively utilized in this disclosure in reference to the brake control units 120a, b. When the driver brakes (actuates brake pedal 150), the controller generates an electrical actuation signal for the associated corner unit 130. Then, the actuator 142, as controlled by the control unit 120A, b, will supply the actual braking force to the rotors 144 associated with each brake. The amount of force a driver provides to the brake pedal 150 may or may not be proportional to the amount of brake force exerted by each of the brakes.

The brake system 100 can reduce creep groan by controlling the brake application force and timing during situations known to cause creep groan. Creep groan is noticeable at static rotor or creeping situations at idle, at low caliper pressures, at first drive off when the brakes are cold, and when the driver is slowly modulating the brake pedal 150. These situations can be sensed by sensors 104 that communicate with the controllers/processor circuit 120. The speed that is indictive of low-speed operation is predefined and may be any speed, such as for example, at a speed below 5 mph. Additionally, the temperature that indicated that the brakes are operating in a cold condition will be based on a predefined temperature range. For example, the brakes may be indicated as operating cold when a temperature is below freezing. As appreciated, other vehicle speeds and temperatures may be utilized as the predefined conditions that prompt operation of the brake system 100 to operate in a manner to reduce noise. The brake system 100 is configured for all situations including high-speed stopping where high brake torques are necessary.

Conventionally, during static and low speed situations, the caliper pressure at all four brake assemblies 140a, b, c, d are of the same value. With the system 100, the processor circuit 120 can determine via input from at least one sensor 104 if the vehicle is operating in a manner where brake noise such as creep groan is likely and, if so, the control unit 120 controls the force and timing of the actuators 142 at the individual brake appropriately to reduce the brake noise (e.g., creep groan). Sensors 104 may include wheel speed sensors, temperature sensors, humidity sensors, noise sensors, vibration sensors, steering angle sensors, etc. The sensors 104 may be part of the brake system 100 or may be separately located on the vehicle such that sensor data may be provided to the brake system 100.

Alternatively, determination of brake noise can be calibrated based on the vehicle's chassis relative to audible or tactical feel of an engineer and stored in the memory 122a, b. Although the brake noise discussed herein relates to brake creep groan, other brake noise arising from the caliper/rotor interaction can be reduced with the system 100.

Information from the sensor(s) 104 may indicate that the front axle brakes are causing creep groan that is audible to the driver and can be felt in the steering wheel and brake pedal 150, the control unit 120 can control the system 100) to attenuate the application force of the front actuators 142 on the front rotors 144. Further, the control strategy can be set to apply a variable force, i.e., a pulsating force, to the brakes. In addition to varying the application and timing of the actuator force using the control strategy for each brake, each brake may also have a separate control strategy with different actuator force and timing. That way, in addition to differentiating between the front and rear axle brakes the control strategy may also differ between the left and right side of the vehicle.

The electronic brake system 100 of the embodiments reduce the creep groan by using the EMB control system to better appropriate the brake pressures during situations known to cause creep groan. Creep groan is noticeable at static or creeping situations at idle, at low caliper pressures, at first drive off when the brakes are cold and when the driver is slowly modulating the brake pedal. Normally, the brake system is designed for all situations including high-speed stopping where high brake torques are necessary. During static and low speed situations the caliper forces at all four brakes are usually the same value, but the EMB system 100 could change the amount of clamp force at the individual brakes appropriately in this situation, to help reduce the creep groan.

For example, if the front axle brake assemblies 140a, b is causing creep groan; the EMB system could be calibrated to reduce the front axle brake forces relative to the rear axle forces. This assumes the rear axle brake assemblies 140c, d have enough torque to provide the appropriate braking power. If the creep groan was caused by the brakes on both axles equally, then half of the noise would be eliminated by emphasizing the rear axle. This would also eliminate any related vibration in the steering wheel (as the rear brakes are not connected to the steering system). The implementation of such an invention will be in the brake controller and transparent to the driver.

Safety measures could be put in place to limit the effects such as vehicle movement, only at low pedal apply positions or force, vehicle is not on a grade, how fast the driver is applying the brakes, etc.

Another disclosed strategy to reduce “creep groan” is by targeting the known clamp force where the issue occurs. For example, creep groan is known to occur from 3 to 7 bar of brake pressure in a hydraulic caliper system. If the values were determined definitively thru testing, they could then be implemented via a look up table or a model; whereby the EMB system 100 would quickly transition thru these values, or skips them, or uses different calipers to provide the same amount of brake force on the vehicle. For example, when releasing the brake pedal with a known issue on the front calipers but not the rear calipers, the front caliper could be released faster thru the known problem region. At the same time holding the rear axle forces higher to compensate for the lower front axle forces, relative to a straight linear conversion of brake pedal release to caliper force release. This also applies in the opposite direction as the brake pedal is applied.

The above example assumes a known issue region, the region could also be actively determined, such as by observing a caliper force sensor, torque sensor, or wheel speed sensor signal.

“Brake judder” is generally a higher vehicle speed concern whereby the brake lining rides up and down in a direction transverse to a direction of the application of a braking force. The up and down movement may be caused by a high and low spots on a rotor. This causes minor audible noise and is felt inside the vehicle as the vehicle vibrates, also felt in the steering wheel, and if the brakes are mechanically connected it is felt in the brake pedal. The same strategies detailed in the creep groan area would applicable. Detection could be determined by testing or determined actively via sensors. When conditions indicative of brake judder are detected, the brake controller deploys a strategy to eliminate or reduce the area causing the issue by sending more force to the opposite axle or opposite caliper (in a safe manner).

“Moan and Groan” is similar to creep groan in that it general occurs at low speeds while the vehicle is reversing. Like creep groan or brake judder, this situation could be passively or actively detected, then the front axle brake forces could be prioritized. For example, if a vehicle was in put in Reverse (this signal is broadcasted by the powertrain or driveline system), then moving at 0 to 5 kph (wheel speeds are also broadcasted or known by the brake system), the front axle brakes could be used with higher forces than the rear axle, eliminating the NVH concern.

Using this EMB controller-based concept provides for the system to be configurable and calibratable to a vehicle's braking system, and related systems (suspension, steering, bushings, etc). The system's detection could be passive or active.

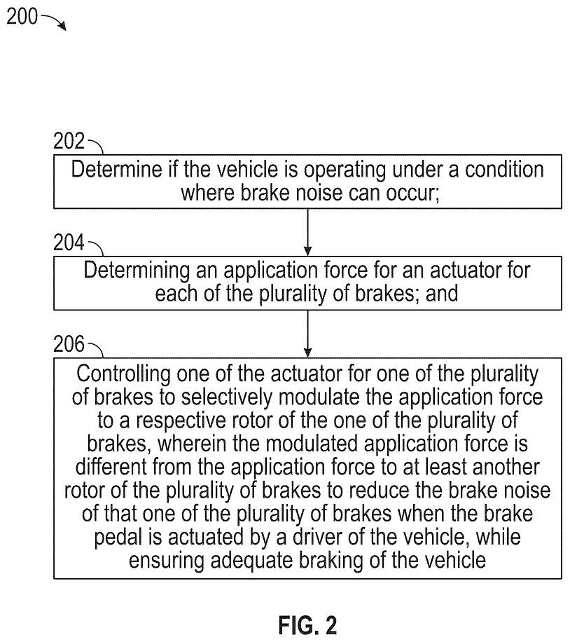

FIG. 2 shows the steps or algorithm for reducing brake noise such as brake creep groan according to an embodiment. FIG. 2 is a flowchart of an example process 200. In some implementations, one or more process blocks of FIG. 2 may be performed by a brake system 100.

As shown in FIG. 2, process 200 may include determining if the vehicle is operating under a condition where brake noise can occur, step 202.

Also, determining an application force for an actuator for each of the plurality of brakes, step 204.

Further, controlling one of the actuators for one of the plurality of brakes to selectively modulate the application force to a respective rotor of the one of the plurality of brakes, step 206. The modulated application force is different from the application force to at least another rotor of the plurality of brakes to reduce the brake noise of that one of the plurality of brakes when the brake pedal is actuated by a driver of the vehicle, while ensuring adequate braking of the vehicle.

For example, brake system 100 may determine if the vehicle is operating under a condition where brake noise can occur. The brake system 100 would then determine an application force for an actuator for each of the plurality of brake assemblies 140a, b, c, d and control one of the actuators 142 for one of the plurality of brake assemblies 140 to selectively modulate the application force to a respective rotor 144 of the one of the plurality of brake assemblies 140. The modulated application force is different from the application force to at least another rotor of the plurality of brakes to reduce the brake noise of that one of the plurality of brakes when the brake pedal is actuated by a driver of the vehicle, while ensuring adequate braking of the vehicle, as described above.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

In one general aspect, the method may include determining if the vehicle is operating under a condition where brake noise can occur, and determining an application force for an actuator for each of the plurality of brakes; controlling one of the actuator for one of the plurality of brakes to selectively modulate the application force to a respective rotor of the one of the plurality of brakes, where the modulated application force is different from the application force to at least another rotor of the plurality of brakes to reduce the brake noise of that one of the plurality of brakes when the brake pedal is actuated by a driver of the vehicle, while ensuring adequate braking of the vehicle. Other embodiments of this aspect include corresponding computer systems, apparatus, and computer programs recorded on one or more computer storage devices, each configured to perform the actions of the methods.

Implementations may include one or more of the following features. The method may include isolating the calipers from the driver when the driver actuates the brake pedal. The method where the front wheel brakes may include a pair of front wheel brakes and the controlling step controls the caliper of each front wheel brake to reduce application force thereof relative to the application force at the rear wheel brakes. The method where the rear wheel brakes may include a pair of rear wheel brakes and the controlling step controls the caliper of each rear wheel brake so as to delay release of the caliper of each rear wheel brake relative to the release of the caliper at each front wheel brake. The method where the front wheel brakes may include a pair of front wheel brakes and the rear wheel brakes may include a pair of rear wheel brakes and controlling step controls a caliper of one of the front wheel brakes and a caliper of one of the rear wheel brakes so as to delay release thereof relative to the other pair of calipers. The method where the controlling step includes preventing the certain ones of the calipers from engaging associated rotors and the method further may include capturing energy during the controlling step. The method where the determining step determines whether the vehicle is operating under a condition where brake creep groan can occur. Implementations of the described techniques may include hardware, a method or process, or a computer tangible medium.

In one general aspect, device may include one or more processors configured to: determine if the vehicle is operating under a condition where brake noise can occur, and determine an application force for an actuator for each of the plurality of brakes control one of the actuator for one of the plurality of brakes to selectively modulate the application force to a respective rotor of the one of the plurality of brakes, where the modulated application force is different from the application force to at least another rotor of the plurality of brakes to reduce the brake noise of that one of the plurality of brakes when the brake pedal is actuated by a driver of the vehicle, while ensuring adequate braking of the vehicle. Other embodiments of this aspect include corresponding computer systems, apparatus, and computer programs recorded on one or more computer storage devices, each configured to perform the actions of the methods.

Implementations may include one or more of the following features. Device where the one or more processors are further configured to: isolate the calipers from the driver when the driver actuates the brake pedal. Device where the front wheel brakes may include a pair of front wheel brakes and the controlling step controls the caliper of each front wheel brake to reduce application force thereof relative to the application force at the rear wheel brakes. Device where the rear wheel brakes may include a pair of rear wheel brakes and the controlling step controls the caliper of each rear wheel brake so as to delay release of the caliper of each rear wheel brake relative to the release of the caliper at each front wheel brake. Device where the front wheel brakes may include pair of front wheel brakes and the rear wheel brakes may include and a pair of rear wheel brakes and controlling step controls a caliper of one of the front wheel brakes and a caliper of one of the rear wheel brakes so as to delay release thereof relative to the other pair of calipers. Device where the one or more processors, when the controlling step includes preventing the certain ones of the calipers from engaging associated rotors and the method, are configured to capture energy during the controlling step. Device where the determining step determines whether the vehicle is operating under a condition where brake creep groan can occur. Implementations of the described techniques may include hardware, a method or process, or a computer tangible medium.

The use of the system 100 to reduce brake creep groan allows changes to the brake linings, vehicle suspension or steering without interruption of the system 100.

The operations and algorithms described herein can be implemented as executable code within the processor circuit as described or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit causes the integrated circuit(s) implementing the controller 120 and/or processor circuit 124 to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit can be implemented, for example, using a non-volatile memory such as a programmable read only memory (PROM) or an EEPROM, and/or a volatile memory such as a DRAM, etc.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A method of reducing brake noise in a vehicle brake system comprising a plurality of brakes, the method comprising:
determining if the vehicle is operating under a condition where brake noise can occur;
determining an application force for an actuator for each of the plurality of brakes; and
controlling the actuator for one of the plurality of brakes to selectively modulate the application brake force to a respective rotor of the plurality of brakes, wherein the modulated application of brake force is different from the application of brake force to at least another rotor of the plurality of brakes to reduce the brake noise of that one of the plurality of brakes while ensuring adequate braking of the vehicle.

2. The method of claim 1, wherein each of the plurality of brakes comprise a caliper and further comprising isolating the application of brake force by the caliper from activation of a control input device such that the application of brake force is not proportional to activation of the control input device.

3. The method of claim 2, wherein the plurality of brakes comprises rear wheel brakes and front wheel brakes comprising a pair of front wheel brakes and controlling the actuator comprises reducing an application of the brake force by the front wheel brakes relative to the application force at the rear wheel brakes.

4. The method of claim 3, wherein the rear wheel brakes comprise a pair of rear wheel brakes and controlling the actuator comprises reducing an application of the brake force at each of the rear wheel brakes so as to delay release of the caliper of each of the rear wheel brakes relative to the release of the caliper at each of the front wheel brakes.

5. The method of claim 3, further comprising controlling a caliper of one of the front wheel brakes and a caliper of one of the rear wheel brakes to delay release thereof relative to calipers of another of the plurality of brakes.

6. The method of claim 2, further comprising preventing select ones of the calipers from engaging associated rotors and the method further comprises capturing energy during control of the actuator.

7. The method of claim 1, further comprises determining whether the vehicle is operating under a condition where brake creep groan can occur.

8. The method of claim 7, further comprises determining if the vehicle is operating under a condition where brake noise can occur comprises sensing a speed of the vehicle below a predefined speed indicative of operation of the vehicle at an idle speed.

9. The method of claim 7, further comprises determining that the vehicle is operating under a condition where brake noise can occur based on sensing a temperature indicative of a temperature of the plurality of brakes that is below a predefined temperature.

10. The method of claim 1, wherein determining if the vehicle is operating under a condition where brake noise can occur comprises detecting conditions at vehicle speeds that cause a brake lining of at least one of the plurality of brakes to move in a direction that is transverse to a direction of the application of braking force.

11. The method of claim 10, wherein controlling one of the actuators of one of the plurality of brakes to reduce a potential for brake noise based on movement of the brake lining comprises increasing braking force to a wheel brake that is opposite the brake operating under the condition where brake noise may occur on a brake on another axle.

12. A device for reducing brake noise in a vehicle brake system comprising a plurality of brakes, the device comprising:
one or more processors configured to:
determine if the vehicle is operating under a condition where brake noise can occur, and
determine an application force for an actuator for each of the plurality of brakes; and
control one of the actuators for one of the plurality of brakes to selectively modulate the application force to a respective rotor of the one of the plurality of brakes, wherein the modulated application force is different from the application force to at least another rotor of the plurality of brakes to reduce the brake noise of that one of the plurality of brakes when a control input device is actuated, while ensuring adequate braking of the vehicle.

13. The device of claim 12, wherein the actuator for each of the plurality of brakes comprises a caliper and the one or more processors are further configured to isolate the calipers from the control input device.

14. The device of claim 13, wherein the plurality of brakes comprises rear brakes and front brakes and a pair of front wheel brakes and the one or more processors are further configured for controlling the caliper of each front wheel brakes to reduce application force thereof relative to the application force at the rear brakes.

15. The device of claim 14, wherein the rear wheel brakes comprise a pair of rear wheel brakes and the one or more processors are further configured for controlling the caliper of each rear wheel brake so as to delay release of the caliper of each rear wheel brake relative to the release of the caliper at each front wheel brake.

16. The device of claim 12, wherein the plurality of brakes comprise a pair of front wheel brakes and a pair of rear wheel brakes; and the one or more processors are further configured for controlling a caliper of one of the front wheel brakes and a caliper of one of the rear wheel brakes so as to delay release thereof relative to the calipers of another of the front wheel brakes and the rear wheel brakes.

17. The device of claim 13, wherein the one or more processors are further configured for preventing select ones of the calipers from engaging associated rotors when applying different brake forces to different ones of the plurality of brakes.

18. The device of claim 17, wherein the one or more processors are further configured to capture energy during the application of force to any one of the plurality of brakes.

19. The device of claim 12, wherein the one or more processors are further configured to determine whether the vehicle is operating under a condition where brake creep groan can occur and to control at least one of the actuators for one of the plurality of brakes based on the determined operating condition.
